(19) United States
(12) Patent Application Publication
(10) Pub. No.: US 2009/0132634 A1
(43) Pub. Date: May 21, 2009

(54) Web based application filing system

(76) Inventor: Michael Monxhwedey, Mount Vernon, NY (US)

Correspondence Address: Ashok Tankha;Of Counsel, Lipton, Weinberger & Husick, 36 Greenleigh Drive, Sewell, NJ, 08080, US

(21) Appl. No.: 11/986,059

(22) Filed: Nov. 20, 2007

(51) Int. Cl. G06F 15/16

(52) U.S. Cl. 709/201

(57) ABSTRACT

The computer implemented method and system disclosed herein enables filing an application at a local government for development and use of land. A web based filing system is provided to the local government. An applicant utilizes the web based filing system for filing the application. The web based filing system enables the applicant and a representative of the applicant to fill out a set of application forms. The applicant then submits the set of application forms to the local government utilizing the web based filing system. Staff of multiple departments of the local government reviews the submitted set of application forms. The web based filing system identifies owners of property adjacent to the land being developed and generates notifications to the property owners. The applicant sends the generated notifications to the property owners. The web based filing system thereby automates the process of filing the application at the local government.

### BACKGROUND

This invention, in general, relates to filing an application for development and use of land. More particularly, this invention relates to filing a land development application at a local government utilizing a web based filing system.

If an owner of a plot of land wants to develop the land, the owner has to file an application at a municipality to acquire permission to develop the land. Typically, the owner needs to visit the municipality to obtain the required forms. The owner has to make an appointment for a pre-application meeting to submit the forms. The owner may then have to call the municipality on a regular basis to check the date and time of the meeting. The owner may then submit multiple copies of the forms, site plans, drawings, and pictures of the land to the municipality. The owner has to visit a department of the municipality to request for a list of names and addresses of property owners within a set radius from the owner's land. The owner may have to wait for an indefinite period of time for completion of the request. The owner may then have to prepare and mail a notice letter to each of the property owners.

Further, the owner may have to visit several departments of the municipality to request for a search of records. The owner may have to contact the municipal departments for the search results and may then have to visit the municipal departments to collect the search results. Further, the owner may have to visit the municipality on a regular basis to check the status of the application. Therefore, there is a need to automate the process of filing the application at a local government in order to reduce the time and effort required to file the application.

Hence, there is an unmet need for a computer implemented method and system to file an application at a local government for development and use of land.

### SUMMARY OF THE INVENTION

The computer implemented method and system disclosed herein addresses the above stated needs for filing an application at a local government for development and use of land. A web based filing system is provided to the local government. An applicant utilizes the web based filing system for filing the application. The applicant may be a land owner or a lessee. The web based filing system enables the applicant and a representative of the applicant to fill out a set of application forms. The representative may be a legal representative or an architect. The applicant then submits the set of application forms to the local government utilizing the web based filing system. Staff of multiple departments of the local government reviews the submitted set of application forms. The applicant receives status alerts from the local government regarding the status of the application.

The applicant searches for records utilizing the web based filing system. The records include certificates of occupancies, tax records, and information about violations on property. The web based filing system identifies owners of property adjacent to the land being developed. The web based filing system generates information of the identified property owners. The information generated by the web based filing system includes a list of names of the property owners and a map with addresses of the property owners. The web based filing system then generates notifications to the property owners. The applicant sends the generated notifications to the property owners.

### BRIEF DESCRIPTION OF THE DRAWINGS

The foregoing summary, as well as the following detailed description of the embodiments, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a method of filing an application at a local government for development and use of land.

FIG. 2 illustrates a system for filing an application at a local government for development and use of land.

FIG. 3 exemplarily illustrates the steps involved in filing an application at a zoning board for development and use of land.

FIG. 4 exemplarily illustrates the steps involved in a rejection of a building permit by an examiner at a municipality.

FIG. 5 exemplarily illustrates the steps involved in the utilization of a web based filing system by an applicant.

FIG. 6 exemplarily illustrates the steps involved in printing and mailing of notifications by an applicant.

### DETAILED DESCRIPTION OF THE INVENTION

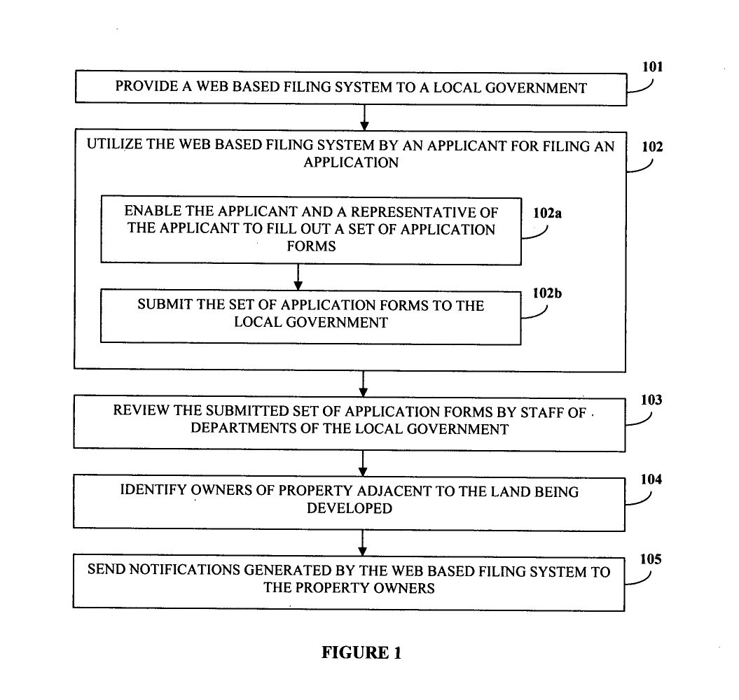

FIG. 1 illustrates a method of filing an application at a local government for development and use of land. A web based filing system 202 is provided 101 to a local government. An applicant 203 may utilize 102 the web based filing system 202 to file the application. The applicant 203 may be a land owner or a lessee. The applicant 203 and a representative 204 of the applicant 203 may fill out 102a a set of application forms on the web based filing system 202. The representative 204 of the applicant 203 may be a legal representative or an architect. The set of application forms include a land development application form, a disclosure statement, a property information form, a statement of principal points, an environmental assessment form, a use variance form, a bulk variance form, site plans, and a certification from a tax collector. Consider an example of a legal representative and an architect of the applicant 203 working on the application utilizing the web based filing system 202. The web based filing system 202 enables the legal representative and the architect to share the application. The legal representative may fill out the statement of principal points while the architect may fill out the property information form. The applicant 203 may then submit 102b the set of application forms to the local government utilizing the web based filing system 202. The applicant 203 receives regular status alerts generated by the web based filing system from the local government regarding the status of the application. The status alerts keep the applicant 203 informed on the application status.

Staff of multiple departments of the local government reviews 103 the submitted set of application forms. A building official of the local government needs to attest the set of application forms in order to deem the application complete. The staff of the departments of the local government may approve or reject the application based on whether the set of application forms are filled out accurately and whether all supporting forms and documents are submitted.

The web based filing system 202 identifies 104 owners of property adjacent to the land being developed. The owners of property within a predefined radius from the land being developed are identified. For example, the web based filing system 202 identifies owners of property within a 200 feet radius from the land being developed. The web based filing system 202 generates information of the identified property owners. The generated information includes a list of names of the property owners and a map with addresses of the property owners. The map may illustrate different map layers including buildings, roads, topography, zoning, and aerial photographs. Further, the web based filing system 202 generates notifications to be sent to the property owners. The notifications generated include notice letters, affidavits, stamps, mailing labels for each of the property owners, and postage for mailing the notice letters and the affidavits to the property owners. The applicant 203 may print the notifications generated by the web based filing system 202. The applicant 203 then sends 105 the printed notifications to property owners. The applicant 203 may also search for records utilizing the web based filing system 202. The records may include certificates of occupancies, tax records, information about violations on property, etc. The applicant 203 is charged a fee to utilize the web based filing system 202 for filing the application. The revenue thus collected over a period of time is shared with the local government.

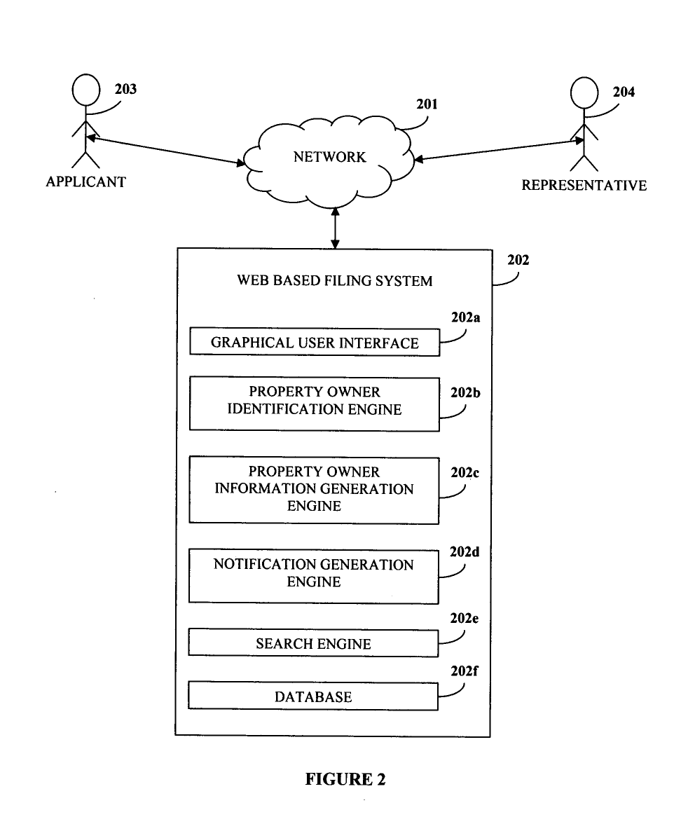

FIG. 2 illustrates a system for filing an application at a local government for development and use of land. The web based filing system 202 disclosed herein comprises a graphical user interface 202a, a property owner identification engine 202b, a property owner information generation engine 202c, a notification generation engine 202d, a search engine 202e, and a database 202f. An applicant 203 and a representative 204 of the applicant 203 access the web based filing system 202 via a network 201.

The applicant 203 and the representative 204 may fill out a set of application forms on the web based filing system 202 utilizing the graphical user interface 202a. The applicant 203 and the representative may share the application and utilize the web based filing system 202 to fill out the set of application forms needed to complete the application. The applicant 203 may then submit the set of application forms to the local government using the graphical user interface 202a. Staff of multiple departments of the local government reviews the submitted set of application forms utilizing the graphical user interface 202a. The notification generation engine 202d generates alerts regarding the status of the application and sends the alerts to the applicant 203.

The property owner identification engine 202b identifies the owners of property within a predefined radius of the land being developed. The property owner identification engine 202c identifies the property owners based on the information provided by the applicant 203 in the set of application forms. Subsequently, the property owner information generation engine 202c generates information of the property owners. The notification generation engine 202d then generates notifications to the property owners. The applicant 203 may then send the generated notifications to the property owners.

Further, the applicant 203 may search for records on the web based filing system 202 using the search engine 202e. The records may include certificates of occupancies, tax records, information about violations on property, etc. The database 202f stores the application, the property owners' information, and the local government records.

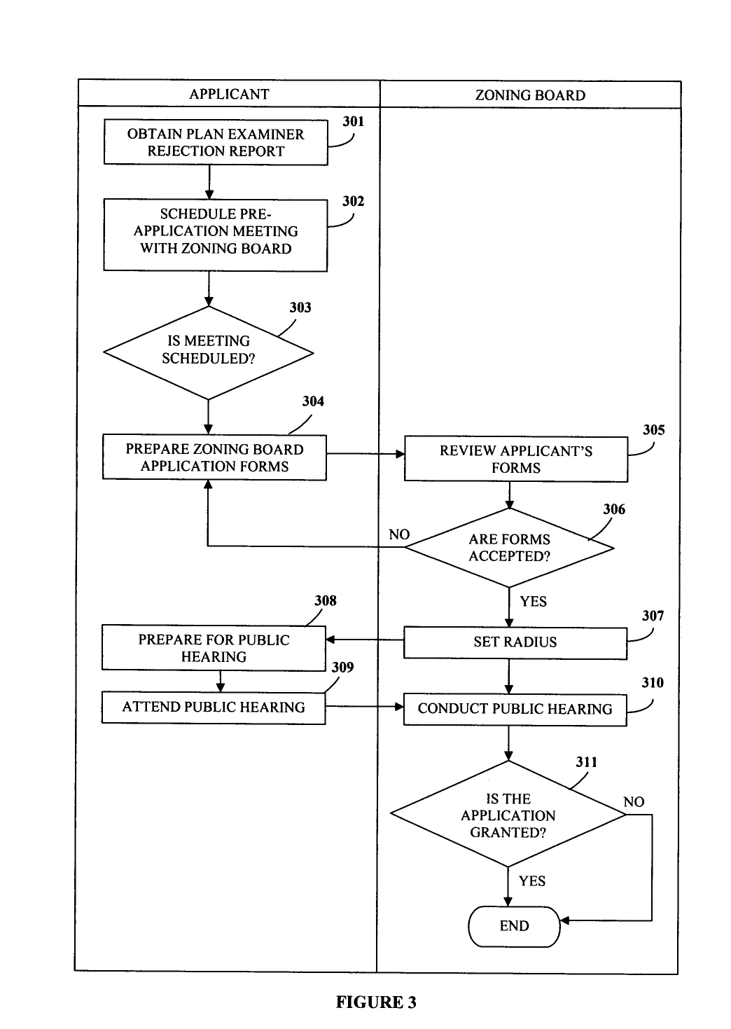

Consider an example of an applicant 203 filing an application at a local government utilizing the web based filing system 202. FIG. 3 exemplarily illustrates the steps involved in filing an application at a zoning board for development and use of land. The applicant 203, Jason may obtain 301 an examiner rejection report from a zoning board through the web based filing system 202. Jason then schedules 302 a meeting with the zoning board utilizing the web based filing system. If the meeting with the zoning board is scheduled 303, Jason prepares 304 zoning board application forms by filling out the application forms provided by the web based filing system 202. A legal representative of Jason and Jason's architect also fill out the required application forms. Jason may then submit the application forms using the web based filing system 202. Staff of multiple departments of the zoning board reviews 305 the application forms submitted by Jason. If the application forms reviewed by the staff of the departments of the zoning board are not accepted 306, Jason may have to prepare a new set of zoning board application forms. If the application forms are accepted 306 by the staff of the departments of the zoning board, the zoning board sets 307 a radius to generate a map with addresses of owners of property within the set radius from Jason's land. The web based filing system 202 generates the map and notifications to be issued to the property owners. Jason then prepares 308 for a public hearing for the property owners. Jason may then attend 309 the public hearing along with all the property owners. The zoning board may then conduct 310 the public hearing. The staff of the departments of the zoning board may attend the public hearing in order to determine 311 whether Jason's zoning board application is to be granted or rejected. The web based filing system 202 then notifies Jason about whether Jason's application is granted or rejected.

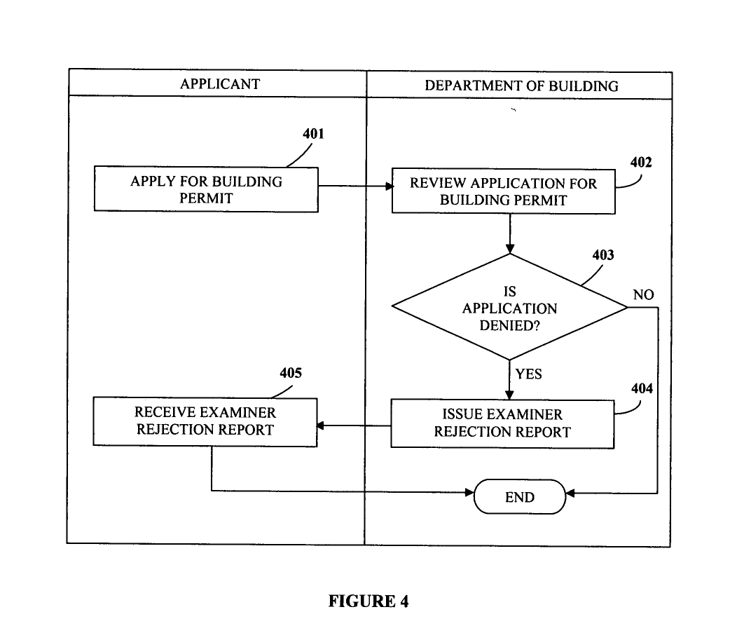

Jason may now apply 401 for a building permit at the department of building of a municipality. Jason may fill out the required set of forms and submit the forms utilizing the web based filing system 202. An examiner of the department of building reviews 402 the application submitted by Jason. If Jason's application is denied 403, the examiner issues 404 an examiner rejection report. Jason receives 405 the examiner rejection report through the web based filing system 202. The steps involved in a rejection of a building permit by an examiner at the municipality are exemplarily illustrated in FIG. 4.

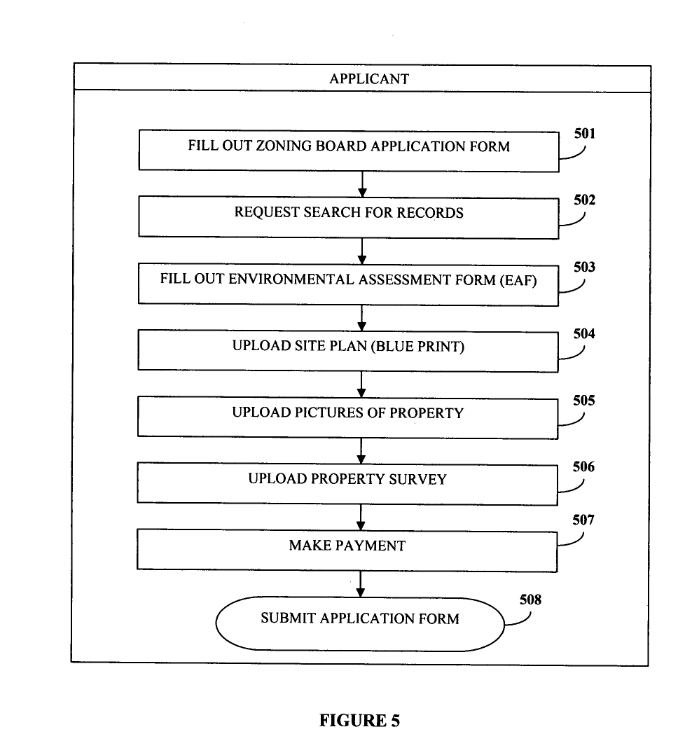

FIG. 5 exemplarily illustrates the steps involved in the utilization of a web based filing system 202 by an applicant 203. The applicant 203, Martha may want to file an application at a zoning board for development and use of property. Martha may fill out 501 a zoning board application form using the web based filing system 202. Martha may then request 502 a search for records from the zoning board using the web based filing system 202. Martha may then fill out 503 an environmental assessment form on the web based filing system 202. Martha's architect may then upload 504 the site plan to the web based filing system 202. Martha may also upload 505 pictures of her property to the web based filing system 202. A legal representative of Martha may then upload 506 the survey of Martha's property to the web based filing system 202. Martha then makes 507 a payment for utilizing the web based filing system 202. Martha submits 508 the land development application to the zoning board utilizing the web based filing system 202. The web based filing system 202 identifies owners of property adjacent to Martha's property. The web based filing system 202 then generates information of the identified property owners and notifications to be issued to the property owners.

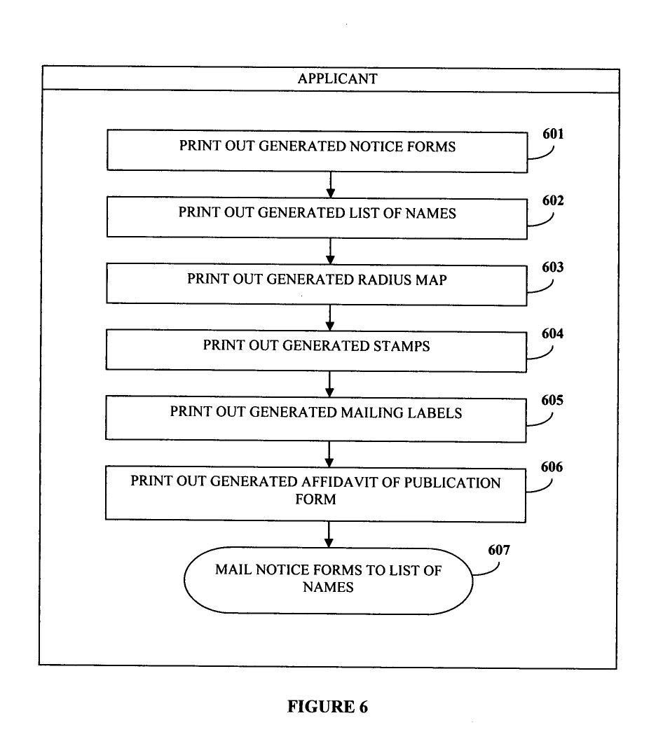

The applicant 203, Martha may print and mail the notifications as exemplarily illustrated in FIG. 6. Martha may print out 601 notice forms generated by the web based filing system 202. Martha may also print 602 the generated list of names of the property owners. Martha may also print 603 the radius map generated by the web based filing system 202. The radius map includes addresses of the property owners. Martha may then print 604 and 605 the stamps and mailing labels required to mail the notice forms to the property owners. Martha may print out 606 the affidavit of publication form generated. Further, Martha may mail 607 the notice forms to each of the property owners.

It will be readily apparent that the various methods and algorithms described herein may be implemented in a computer readable medium appropriately programmed for general purpose computers and computing devices. Typically a processor, for e.g., one or more microprocessors will receive instructions from a memory or like device, and execute those instructions, thereby performing one or more processes defined by those instructions. Further, programs that implement such methods and algorithms may be stored and transmitted using a variety of media, for e.g., computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A ‘processor’ means any one or more microprocessors, Central Processing Unit (CPU) devices, computing devices, microcontrollers, digital signal processors or like devices. The term ‘computer-readable medium’ refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include Dynamic Random Access Memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during Radio Frequency (RF) and Infrared (IR) data communications. Common forms of computer-readable media include, for example, a floppy disk, a flexible disk, hard disk, magnetic tape, any other magnetic medium, a Compact Disc-Read Only Memory (CD-ROM), Digital Versatile Disc (DVD), any other optical medium, punch cards, paper tape, any other physical medium with patterns of holes, a Random Access Memory (RAM), a Programmable Read Only Memory (PROM), an Erasable Programmable Read Only Memory (EPROM), an Electrically Erasable Programmable Read Only Memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, or JAVA. The software programs may be stored on or in one or more mediums as an object code. A computer program product comprising computer executable instructions embodied in a computer-readable medium comprises computer parsable codes for the implementation of the processes of various embodiments.

Where databases are described such as the database 202f, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats including relational databases, object-based models and/or distributed databases could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel® processors, AMD® processors, Sun® processors, IBM® processors etc., that are adapted to communicate with the computer. Any number and type of machines may be in communication with the computer.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

I claim:

1. A computer implemented method of filing an application at a local government for development and use of land, comprising the steps of:
providing a web based filing system to said local government;
utilizing said web based filing system by an applicant for filing said application, comprising the steps of:
enabling said applicant and a representative of the applicant to fill out a set of application forms;
submitting said set of application forms to the local government utilizing the web based filing system;
reviewing said submitted set of application forms by staff of a plurality of departments of the local government;
identifying owners of property adjacent to said land being developed; and
sending notifications generated by the web based filing system to said property owners by the applicant;
whereby the web based filing system enables the applicant to file the application at the local government for said development and said use of the land.

2. The computer implemented method of claim 1, wherein the applicant is one of an owner of the land and a lessee.

3. The computer implemented method of claim 1, wherein said representative is one of a legal representative and an architect.

4. The computer implemented method of claim 1, wherein the applicant searches for records utilizing the web based filing system, wherein said records comprise certificates of occupancies, tax records, and information about violations on property.

5. The computer implemented method of claim 1, wherein the applicant receives status alerts from the local government regarding status of the application.

6. The computer implemented method of claim 1, further comprising a step of generating information of the property owners by the web based filing system, wherein said information comprises list of names of the property owners and a map with addresses of the property owners.

7. The computer implemented method of claim 1, further comprising a step of generating said notifications to the property owners by the web based filing system, wherein the notifications comprise notice letters, affidavits, mailing labels for each of the property owners, and postage for mailing said notice letters and said affidavits to the property owners.

8. The computer implemented method of claim 1, wherein the applicant prints the application to be submitted to the local government, wherein the application comprises the set of application forms, affidavits, and legal notices.

9. A computer implemented system for filing an application at a local government for development and use of land, comprising:
a web based filing system, comprising:
a graphical user interface for filling out and submitting a set of application forms by an applicant and a representative of said applicant;
a property owner identification engine for identifying owners of property adjacent to said land being developed; and
a notification generation engine for generating notifications to said property owners.

10. The computer implemented system of claim 9, wherein said web based filing system comprises a property owner information generation engine for generating information of the property owners.

11. The computer implemented system of claim 9, wherein said graphical user interface enables reviewing of said set of application forms by staff of a plurality of departments of said local government.

12. The computer implemented system of claim 9, wherein said web based filing system comprises a search engine for enabling the applicant to search for records, wherein said records comprise certificates of occupancies, tax records, and information about violations on property.

13. The computer implemented system of claim 9, wherein said notification generation engine generates status alerts for the applicant regarding status of said application.

14. The computer implemented system of claim 9, wherein said web based filing system comprises a database for storing said application, information about property owners, and local government records.

15. A computer program product comprising computer executable instructions embodied in a computer-readable medium, wherein said computer program product comprises:
a first computer parsable program code for enabling submission of a set of application forms to a local government by an applicant for development and use of land; and
a second computer parsable program code for identifying owners of property adjacent to said land being developed.

16. The computer program product of claim 15, further comprising a third computer parsable program code for searching for records by said applicant.

17. The computer program product of claim 15, further comprising a fourth computer parsable program code for generating status alerts for said applicant regarding status of an application.

18. The computer program product of claim 15, further comprising a fifth computer parsable program code for generating information of said property owners.

19. The computer program product of claim 15, further comprising a sixth computer parsable program code for generating notifications to said property owners.
